(19) United States
(12) Patent Application Publication
(10) Pub. No.: US 2009/0313105 A1
(43) Pub. Date: Dec. 17, 2009

(54) SYSTEM AND METHOD FOR A MOBILE VOUCHER

(76) Inventor: Stefan Magnusson, London (GB)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/482,289

(22) Filed: Jun. 10, 2009

Related U.S. Application Data
(60) Provisional application No. 61/060,761, filed on Jun. 11, 2008.

(51) Int. Cl. G06Q 30/00; G06Q 10/00; G06F 3/048; H04W 4/12

(52) U.S. Cl. 705/14.25; 705/14.53; 705/14.64; 705/21; 715/760; 455/466

(57) ABSTRACT

A mobile voucher apparatus for administrating mobile vouchers redeemable at a Point-of Sale, the mobile voucher apparatus comprising: a module for acquiring a plurality of prepaid card accounts, unallocated to cardholders; a processor for associating a card account with a mobile device number; a transceiver for sending a mobile voucher message to the mobile device number associated with said account; wherein said mobile voucher message comprises at least transaction particulars acceptable as consideration for purchase at a Point-of-Sale.

### CROSS-REFERENCE TO RELATED APPLICATION

This application claims the benefit of U.S. Provisional Patent Application Ser. No. 61/060,761, filed Jun. 11, 2008, entitled “Mobile Voucher”, which is hereby incorporated herein by reference in their entirety.

### TECHNICAL FIELD OF THE INVENTION

The present invention relates generally to transactions involving vouchers. More specifically, the various embodiments of the invention relate to the apparatus and methods suitable for transactions involving mobile vouchers corresponding to a prepaid account of credit redeemable at a point of sale device.

### BACKGROUND OF THE INVENTION

Various types of prepaid payment cards have been in existence for some time. In both appearance and use, a prepaid payment card may be very similar to a credit or debit card, giving users the ability to purchase products and services with the card up to an amount not exceeding the balance that has been preloaded onto the card. This type of card is favorable for several reasons, one of which is that the user can benefit from increased security during transactions without the risk of running into debt, since prepaid payment cards have no credit or overdraft facility.

When used for making purchases at a retail store, for instance, prepaid cards work in exactly the same way as a credit or debit card. In other words, the user hands the card to the cashier who processes the card by swiping, placing in a card reader or entering the card number into the point of sale terminal. Where applicable, the user may be asked to enter a PIN number on an electronic keypad. Alternatively, the user may be asked to sign a payment slip so that their signature can be matched with that on the back of the card. Most merchants can also accept a card transaction where the cardholder is not physically present, for example, when a purchase is made over the telephone or when a transaction has been incorrectly entered the first time. In all events, the total cost of the items being purchased will be taken charged from the card in consideration for the purchase in order to complete the transaction. Sometimes the card is cleared immediately through a live connection with the merchant's acquiring bank, sometimes the transaction is cleared in a batch process that may take a few days.

Some prepaid payment cards can be used on the Internet. Again, by analogy to credit or debit cards, the user finds the items they wish to buy on a website, navigates to the “checkout” and fills in the details from the card, e.g. the card number and the security code. Thereafter the transaction is completed by deducting the appropriate amount from the prepaid card.

Recently, prepaid payment cards have been used to transact gift exchanges in a manner that is more convenient and safer than giving cash. In contrast to a regular gift voucher or card, which are usually tied to a particular retailer or brand, a prepaid gift card can be used at other retail locations with the necessary facilities to redeem prepayment cards.

However, no currently known technology provides a system for facilitating transactions involving mobile vouchers corresponding to a prepaid account of credit redeemable at a point of sale by a mobile device user.

### SUMMARY OF THE INVENTION

The present invention provides a system and method for administrating mobile vouchers redeemable at a Point-of-Sale. In architecture, invention may be conceptualized as a system that includes a module for acquiring a plurality of financial transaction card accounts, unallocated to cardholders and a processor for associating a card account with a mobile device number. Moreover, the system includes a transceiver for sending a mobile voucher message to the mobile device number associated with said account, and wherein said mobile voucher message comprises at least transaction particulars acceptable as consideration for purchase at a Point-of-Sale.

The present invention can also be viewed as a method for administrating mobile vouchers redeemable at a Point-of-Sale. The method operates by (1) acquiring a plurality of financial transaction card accounts, unallocated to cardholders; (2) associating a card account with a mobile device number; and (3) sending a mobile voucher message to the mobile device number associated with said account, wherein said mobile voucher message comprises at least transaction particulars acceptable as consideration for purchase at a Point-of-Sale.

Additional advantages and novel features of the invention will be set forth in part in the description which follows, and in part will become apparent to those skilled in the art upon examination of the following and accompanying drawings or may be learned by practice of the invention.

### BRIEF DESCRIPTION OF THE DRAWINGS

For a better understanding of the invention and as to how the same may be carried into effect reference will now be made, by way of example only, to the accompanying drawings, in which:

FIG. 1 is a block diagram illustrating an example of an environment of a mobile voucher transaction system according to an embodiment of the present invention; and

FIG. 2 is a flow chart illustrating an example of the operation of the voucher process with the mobile voucher transaction system of the present invention, as shown in FIG. 1.

### DETAILED DESCRIPTION OF THE INVENTION

Those skilled in the art will appreciate that while this disclosure describes what is considered to be the best mode and, where appropriate, other modes of performing the invention, the invention should not be limited to the specific configurations and methods disclosed in this description of the preferred embodiment.

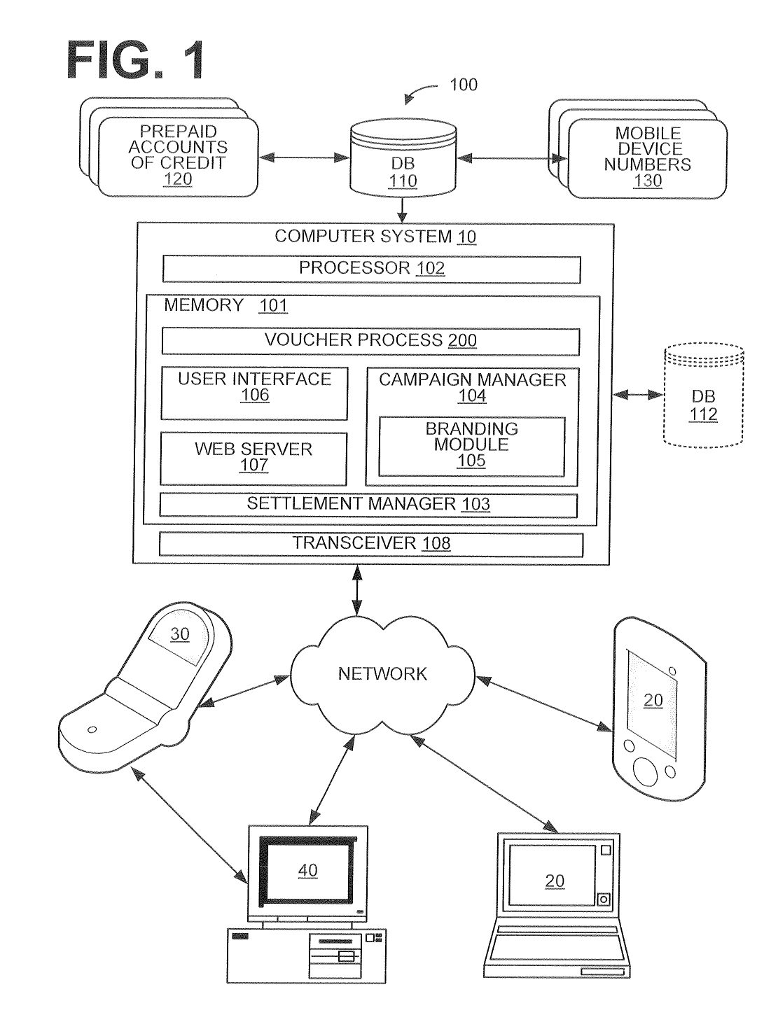

FIG. 1 illustrates a mobile voucher transaction system 100 according to an embodiment of the present invention. The mobile voucher transaction system 100 comprises a computer system (mobile voucher apparatus) 10, at least one initiating device 20, at least one mobile receiving device 30 and a point-of-sale (POS) terminal 40.

The computer system 10, initiating device 20, mobile receiving device 30 and POS terminal 40 are in communication via a suitable network 50, which may be the Internet and/or cellular network as appropriate. The POS terminal 40 can be any suitable POS terminal capable of accepting payment by inputting transaction particulars. The method of input may be anything from operator keying, swipe, short message service (SMS), manufacturing message specification (MMS), wireless application protocol (WAP) message, and near field communication (NFC), Bluetooth, optical scanning, WIFI or other suitable means.

The computer system 10 further comprises a memory 101, processor 102, a transceiver 108, a main database 110 and a temporary database 112. The processor 102 is a hardware device for executing software that can be stored in memory 101. The memory 101 further includes a voucher process 200, a settlement manager 103, a campaign manager 104 with a branding module 105, a user interface 106, and a web server 107.

The processor 102 can be virtually any custom made or commercially available processor, a central processing unit (CPU) or an auxiliary processor among several processors associated with the computer system 10, and a semiconductor based microprocessor (in the form of a microchip) or a macroprocessor. Examples of some suitable commercially available microprocessors include, but are not limited to: an 80x86, Pentium, Celeron, Xeon or Itanium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., a 68xxx series microprocessor from Motorola Corporation, U.S.A. or the like. The processor 102 is configured to execute software stored within the memory 101, to communicate data to and from the memory 101, and to generally control operations of the computer pursuant to the software. The mobile voucher transaction system 100 and the operating system are read, in whole or in part, by the processor 102, perhaps buffered within the processor 102, and then executed.

The memory 101 can include any one or combination of volatile memory elements (e.g., random access memory (RAM, such as dynamic random access memory (DRAM), static random access memory (SRAM), etc.)) and nonvolatile memory elements (e.g., read only memory (ROM), erasable programmable read only memory (EPROM), electronically erasable programmable read only memory (EEPROM), programmable read only memory (PROM), tape, compact disc (CD-ROM), DVD read on memory, magnetic disk, diskette, cartridge, cassette or the like, etc.). Moreover, the memory 101 may incorporate electronic, magnetic, optical, and/or other types of storage media. Note that the memory 101 can have a distributed architecture where various components are situated remote from one another, but still can be accessed by processor 102.

The software in memory 101 may include one or more separate programs, each of which comprises an ordered listing of executable instructions for implementing logical functions. In the example illustrated in FIG. 1, the software in the memory 101 for the mobile voucher transaction system 100 includes, but is not limited to, a suitable operating system (not shown) and the voucher process 200 of the present invention. The memory 101 for the mobile voucher transaction system 100 further includes a settlement manager 103, a campaign manager 104 with a branding module 105, a user interface 106, a web server 107.

The operating system essentially controls the execution of other computer programs, such as the voucher process 200, settlement manager 103, campaign manager 104 with the branding module 105, user interface 106, and web server 107, and provides scheduling, input-output control, file and data management, memory management, and communication control and related services. However, it is contemplated by the inventors that the mobile voucher transaction system 100 of the present invention is applicable on all other commercially available operating systems.

The mobile voucher transaction system 100, including the voucher process 200, may be implemented as a source program, executable program (object code), script, or any other entity comprising a set of instructions to be performed. When a source program, then the program is usually translated via a compiler, assembler, interpreter, or the like, which may or may not be included within the memory 101, so as to operate properly in connection with the operating system. Furthermore, the mobile voucher transaction system 100, including the voucher process 200, can be written as (a) an object oriented programming language, which has classes of data and methods, or (b) a procedure programming language, which has routines, subroutines, and/or functions, for example but not limited to, C, C++, Pascal, BASIC, FORTRAN, COBOL, Perl, Java, ADA and the like.

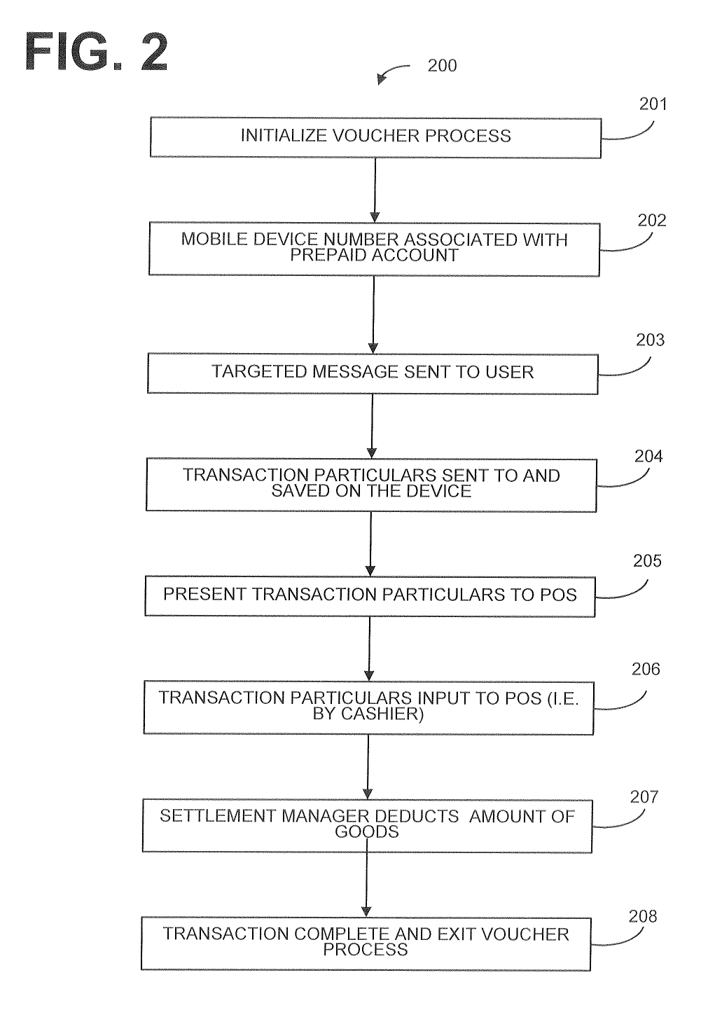

When the mobile voucher transaction system 100 is implemented in software, as is shown in FIG. 2, it should be noted that the mobile voucher transaction system 100 can be stored on virtually any computer readable medium for use by or in connection with any computer related system or method. In the context of this document, a computer readable medium is an electronic, magnetic, optical, or other physical device or means that can contain or store a computer program for use by or in connection with a computer related system or method. The mobile voucher transaction system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the mobile voucher transaction system 100 is implemented in hardware, the mobile voucher transaction system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

As illustrated, the remote devices 20, 30 and 40 include many of the same components as computer system 10 described with regard to FIG. 1. Remote device 20, 30 and 40 include but are not limited to, PCs, workstations, laptops, PDAs, pagers, WAP devices, non-WAP devices, cell phones, palm devices and the like.

The main database 110 comprises records of a plurality of prepaid accounts of credit 120 and is also used to store a plurality of mobile device numbers 130. The plurality of prepaid accounts of credit 120 are available from financial institutions such as credit card providers and transaction processors by paying a predetermined amount of money to the relevant provider in exchange for an account corresponding to the predetermined amount of money. According to one embodiment of the present invention, the prepaid accounts of credit 120 are purchased in batches from the relevant card providers but not allocated to individual consumers. To this effect, the computer system 10 may also be connected to one or more third party computer systems, the third party computer systems belonging to card transaction processors and the computer system 10 configured to send money in exchange for the plurality of prepaid accounts of credit 120 details.

Each account in the prepaid accounts of credit 120 is identifiable with an account ID. Each account may also have transaction particulars, such as an associated card number (card ID) which can be used to remit money from the account at a POS terminal 40, over the Internet or via telephone. Typically, financial institutions and merchants accept a type of transaction verified only by the entry of the transaction particulars to a suitable POS terminal 40, irrespective of whether the cardholder is present.

The transceiver 108 is logically linked to user interface 106 by a suitable data connection. According to one embodiment of the present invention, the user interface 106 is configured to receive one or more mobile device numbers corresponding to recipient users. This may be done by an initiating user via an initiating device 20, through a computer connected to the Internet or by some other suitable mechanism. Therefore, an initiating user, for instance a person who wishes to give a gift to a recipient user, is able to use the user interface 106 to purchase an account in the prepaid account of credit 120 and enters the mobile device number of the recipient user in the plurality of mobile device numbers 130. The user interface 106 may be generated at least in part by web server 107.

Upon receipt of said one or more mobile device numbers, the user interface 106 passes the received data to the processor 102, this in turn passes the one or more mobile device numbers to main database 110. Alternatively or in addition, main database 110 may be pre-populated with a plurality of mobile device numbers, for example as part of an advertising promotion/campaign.

In use, the processor 102 is operable to associate each of the one or more mobile device numbers in with an individual prepaid account of credit in the main database 110. The processor 102 also creates transaction particulars for each association between an individual mobile device number and an individual prepaid account of credit. This data is stored in the temporary database 112. The transaction particulars, like a credit or debit card number, can be presented at a POS terminal 40 as consideration for a purchase and in practice may be used as a mobile voucher. The transaction particulars may comprise, for example, a series of digits (e.g. 16 digits) plus a security code (e.g. 3 digits) in a format which is redeemable at a Point-of-Sale terminal.

The processor 102 packages the transaction particulars into an electronic voucher and sends the voucher to the mobile receiving device 30 of a recipient user, through the transceiver 108. According to one embodiment, the voucher is a data packet viewable on a mobile phone further comprising a branded campaign message and/or advertisement. It may also comprise other information, such as merchant instructions, WAP links to internet sites viewable on a mobile device storing information associated with the coupon and suchlike. Examples of Internet sites which may be relevant are sites displaying terms and conditions for use of the voucher or user instructions relating to the product to which the voucher applies.

According to one embodiment of the present invention, before issuing the voucher to the recipient user, the processor 102 constructs a targeted message comprising data associated with the transaction particulars for transmission to a recipient. In this case, the message may contain a uniform resource locator (URL) or other suitable link identifying a website, for example a WAP site, accessible from the recipient's mobile device. The WAP site is generated and administrated by web server 107.

According to one embodiment, users can be targeted for a campaign, such as an advertising promotion, by a particular vendor or original equipment manufacturer (OEM). Aspects of the campaign are managed by the campaign manager 104, which is described in more detail below. According to one example, eligible users are sent a WAP link (which may be branded) to their mobile device. When the link is followed by the mobile device user, they are taken to a website hosted by web server 107 so that they can download a mobile voucher. Therefore, it may not be necessary to require any verification of the user before issuing the mobile voucher. Throughout this description, the term “mobile voucher” should be construed to mean a voucher issued to a mobile device, which may be part of a campaign part of a gift mechanism or any other suitable mechanism.

The targeted message may also be used as part of a validation process. Hence, according to one example, the mobile device user is able to navigate to a website in order to verify their identity. This may involve entry of one or more pieces of personal identification information, for instance their mobile device number, name, date of birth etc., likes and dislikes or other consumer information. According to one example, the user's mobile device number is extracted from a portion of the data packet transmitted to the WAP site.

User browsing behavior may also be ascertained from data transmitted from the mobile device. This information can be extracted and processed accordingly by processor 102.

Thus the transceiver 108 is operable to transmit the targeted message to the mobile device number of the recipient user and (ii) receive returned data from the mobile device. According to one example, the returned data is generated in response to user inputs (for instance personal identification information, likes and dislikes, etc.) to the WAP website hosted by web server 107. According to another example, the recipient user may send a text message back to the computer system 10 containing similar data, which is then processed accordingly by the processor 102.

Where verification of identity is employed, once the recipient user has been verified, the voucher comprising the transaction particulars will be issued to their mobile receiving device 30.

Once the user receives the mobile voucher comprising the transaction particulars, the user can then redeem the voucher, for instance, at any retail store or over the Internet. Hence, according to one example a user takes their mobile device comprising the mobile voucher into a shop, chooses some items to be purchased and takes them to the Point-of-Sale (POS) 40. Alternatively, the voucher may only be redeemable against a specific item or items from a particular promoter (e.g. in the case of a campaign). At the Point-of-Sale, when the cashier asks them for payment, the voucher user presents transaction particulars from their mobile receiving device 30. This may involve quoting the number from the card issuer ID to the cashier or handing the mobile device directly to the cashier so that they may enter the card ID into the POS terminal 40, or processing the transaction particulars in any way suitable for the format in which they are presented, for example from an NFC enabled mobile device to an NFC reader connected to the POS terminal 40.

Once the card ID has been entered into the POS terminal 40, the transaction details are sent back to computer system 10 through transceiver 108. Upon receipt of the transaction details, the settlement manager 103 subtracts the amount 207 corresponding to goods purchased from the prepaid account of credit 120. Where the prepaid account of credit 120 becomes fully depleted after one or more transactions, the settlement manager 103 may instruct the processor 102 to delete the temporary card ID record from temporary database 112, In addition, the processor 102 may update a log (e.g. stored in main database 110) based on user behavior, for instance items purchased and other consumer information, so that the user can be considered for future targeted promotional campaigns.

It should be noted that the voucher according to embodiments of the present invention is not specific as to the item(s) and the prepaid account of credit 120 is not necessarily fully depleted after a given transaction so the recipient user may later present the transaction particulars at another Point-of-Sale.

The settlement manager 103 may also collect audit information detailing a transaction. In this regard, the mobile device and/or POS terminal 40 may be loaded with a client application operable to report back such information to the settlement manager 103.

Advantageously, according to the embodiments of the present invention the POS terminal 40 does not require any additional equipment or configuration beyond that which exists for normal pre-pay/debit/credit card transactions. To this effect, the cashier only has to enter the transaction particulars (e.g. the card ID and security code) into the POS terminal 40 in order to complete a transaction. The vouchers of the embodiments of the present invention can therefore be used at millions of retail outlets worldwide.

Although the embodiments of the invention have been described with reference to redeeming vouchers at a POS terminal 40, it will be apparent to the skilled person that the vouchers are also redeemable over the internet or via telephone in much the same way.

According to one embodiment, the campaign manager 104 is able to issue vouchers to a plurality of mobile device numbers 130 stored in main database 110. These vouchers are typically promotional vouchers issued by different vendors. The promotional vouchers are typically tied to a particular product or particular brand of products; however, they are technically redeemable at any POS terminal 40 that accepts the relevant network transaction. The campaign manager 104 further comprises a branding module 105 configured to brand the vouchers sent to the recipient users with an appropriate advertisement, logo or other branding as required. In this regard, the branding module 105 may have access to data comprising graphics, advertising slogans and other promotional materials for any number of promoters.

According to one example, the campaign manager 104 may issue promotional vouchers based on consideration of information beyond only the mobile device number 130. To this effect, the main database 110 may further comprise at least some information identifying further attributes of the user. Hence, each mobile device number 130 may be stored in account in the main database 110 together with some information which a vendor may find useful during a promotional campaign, for instance, age, sex, likes and dislikes and other consumer preferences. Such information may be gathered, for instance, during the optional verification step as outlined above. Alternatively or in addition this information may be gathered by some other mechanism, for instance, user browsing behavior or provided by a third party.

FIG. 2 illustrates a typical process carried out according to embodiments of the present invention. The voucher process is initiated at 201 either by an initiating user or a promoter. The mobile device number of an individual recipient user is associated 202 with a temporary prepaid account ID corresponding to a predetermined amount of money (and which exists for the lifetime of the voucher). Optionally, the mobile device number 130 may be associated with a permanent account ID stored in main database 110, together with additional user information such as consumer preference information. A targeted message is sent 203 to the recipient user informing them that they have received a mobile voucher. According to one example, the user then sends a confirmation message confirming receipt of the message. According to one example, the confirmation message also acts to validate the recipient user. The temporary prepaid account ID has associated with it transaction particulars (e.g. card number and security code). The transaction particulars are then transmitted 204 to the mobile device. According to one example, the targeted message at step 203 may contain the mobile voucher itself with no requirement for the recipient user to take any further steps before being able to redeem the voucher at a point of sale. In another example the recipient is sent a WAP link by SMS which they are requested to follow. This takes the recipient to a WAP site uniquely associated with the recipient's mobile device number, where the transaction details are stored as part of a branded voucher.

In order to carry out a transaction, the transaction particulars may be presented 205 at a POS terminal 40. Thereafter, the cashier inputs 206 the card number (together with the security code where applicable) into the POS terminal 40. The POS terminal 40 then transmits details of the transaction back to the computer system 10 where the settlement manager 103 deducts 207 an amount corresponding to the goods purchased from the prepaid account of credit 120 and the transaction is deemed to be complete 209.

Therefore, the embodiments of the present invention advantageous over the prior art systems for several reasons. One advantage is that the voucher can be redeemed at any point of sale using just a mobile device, with no requirement of any additional equipment or special configuration of equipment which already exists for pre-pay/credit/debit card transactions. In addition, since the accounts are pre-paid there are no credit checks, which mean that a user can get a card ID without worrying about credit history.

According to another advantage, the embodiments of the present invention may be used by a parent to send a “pocket money” voucher to a child's mobile device. Not only is this more secure than giving cash or paper gift vouchers, but like a credit card the initiating user is able to get a full breakdown of spending on the card by virtue of the client application loaded onto the mobile device and/or POS terminal 40 as described above. Hence, according to this example a parent is able to manage a child's spending.

Any process descriptions or blocks in flow charts should be understood as representing modules, segments, or portions of code which include one or more executable instructions for implementing specific logical functions or steps in the process. Alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

Those skilled in the art will appreciate that while this disclosure has described what is considered to be the best mode and, where appropriate, other modes of performing the invention, the invention should not be limited to the specific configurations and methods disclosed in this description of the preferred embodiment. The invention has a broad range of applications in many different types of transactions, and the embodiments of the present invention described in this disclosure may take a wide range of modifications without departing from the inventive concept as defined in the appended claims.

1. A mobile voucher apparatus for administrating mobile vouchers redeemable at a point-of-sale device, the apparatus comprising:
a module for acquiring a plurality of financial transaction card accounts, unallocated to cardholders;
a processor for associating a card account with a mobile device number;
a transceiver for sending a mobile voucher message to the mobile device number associated with said card account,
wherein said mobile voucher message comprises at least transaction particulars acceptable as consideration for purchase at the point-of-sale device.

2. The mobile voucher apparatus according to claim 1 wherein transaction particulars comprise account holder not present particulars.

3. The mobile voucher apparatus according to claim 2 wherein the account holder not present particulars comprise a plural digit card number and optionally a security code.

4. The mobile voucher apparatus according to claim 1 wherein the voucher message comprises code to automatically communicate with the point-of-sale device and the mobile device comprises a client application capable of reading the code and causing said device to communicate with the point-of-sale device.

5. The mobile voucher apparatus according to claims 1 wherein the voucher message is in a format that is selected from the group consisting of short message service (SMS), manufacturing message specification (MMS), wireless application protocol (WAP) message, and near field communication (NFC).

6. The mobile voucher apparatus according to any claim 1 wherein the processor is further operable to generate a record with a link between a card account and a mobile device number.

7. The mobile voucher apparatus according to claim 1 wherein the processor is configured to associate a card account with a mobile device number responsive to instructions from a first user wishing to send a mobile gift to a second user.

8. The mobile voucher apparatus according to claim 1 further comprising a campaign manager module operable to associate a card account with a mobile device number of selected consumers as part of an advertising campaign.

9. The mobile voucher apparatus according to claim 8 comprising historic consumer behavior data, and wherein said processor accesses said data to select a consumer.

10. The mobile voucher apparatus according to claim 1 wherein the mobile voucher message comprises branding.

11. The mobile voucher apparatus according to claim 1 wherein the mobile voucher message comprises text.

12. The mobile voucher apparatus according to claim 1 wherein prior to sending a mobile voucher to the mobile device, the transceiver sends a first message to the mobile device.

13. The mobile voucher apparatus according to claim 12 wherein the first message comprises a link message to a mobile Internet server provided with further branding/merchandising content.

14. The mobile voucher apparatus according to claim 13 wherein the link message is branded.

15. The mobile voucher apparatus according to claim 12 wherein the first message in WAP format.

16. The mobile voucher apparatus according to claim 1 further comprising a settlement manager module configured to determine when a transaction does not deplete funds in a prepaid card account.

17. The mobile voucher apparatus according to claim 16 wherein the settlement manager module is configured to receive audit information about a transaction event.

18. The mobile voucher apparatus according to claim 1 wherein the plurality of financial transaction card accounts are prepaid accounts.

19. A method of administrating mobile vouchers redeemable at a point-of-sale device comprising a computer readable medium usable by a processor, and the computer readable medium having stored thereon a sequence of instructions which, when executed by the processor, cause the processor to interact with and control a computing device providing the administration of mobile vouchers, the method comprising:
acquiring a plurality of financial transaction card accounts, unallocated to cardholders;
associating a card account with a mobile device number;
sending a mobile voucher message to the mobile device number associated with said card account, wherein said mobile voucher message comprises at least transaction particulars acceptable as consideration for purchase at the point-of-sale device.

20. The method according to claim 19 wherein transaction particulars comprise account holder not present particulars.

21. The method according to claim 20 wherein the account holder not present particulars comprise a plural digit card number and optionally a security code.

22. The method according to claim 19 wherein the associating comprises generating a record with a link between a card account and a mobile device number.

23. The method according to claim 22 wherein the associating is performed by a campaign manager selecting consumers as part of an advertising campaign.

24. The method according to claim 23 wherein consumers are selected based on criteria linked to historic consumer behavior.

25. A computer program product that includes a computer readable medium usable by a processor, the computer readable medium having stored thereon a sequence of instructions which, when executed by the processor, causes the processor to interact with and control a computing device to administer mobile vouchers by:
acquiring a plurality of financial transaction card accounts unallocated to cardholders;
associating a card account with a mobile device number; and
sending a mobile voucher message to the mobile device number associated with said card account, wherein said mobile voucher message comprises at least transaction particulars acceptable as consideration for purchase at a Point-of-Sale device.
